(19) United States
(12) Patent Application Publication
(10) Pub. No.: US 2022/0398457 A1
(43) Pub. Date: Dec. 15, 2022

(54) Distributed Deep Learning System and Distributed Deep Learning Method

(71) Applicant: Nippon Telegraph and Telephone Corporation, Tokyo (JP)

(72) Inventors: Yuki Arikawa, Tokyo (JP); Kenji Tanaka, Tokyo (JP); Tsuyoshi Ito, Tokyo (JP); Kazuhiko Terada, Tokyo (JP); Takeshi Sakamoto, Tokyo (JP)

(21) Appl. No.: 17/776,848

(22) PCT Filed: Dec. 2, 2019
(86) PCT No.: PCT/JP2019/046967

§ 371 Date: May 13, 2022

(51) Int. Cl. G06N 3/08

(52) U.S. Cl. CPC G06N 3/08

(57) ABSTRACT

A distributed deep learning system includes a plurality of computation nodes mutually connected through a communication network, wherein each of the plurality of computation nodes includes a network processing unit including: a reception section that receives an OAM packet indicating states of the plurality of computation nodes; an OAM processing section that makes a record, in the OAM packet received by the reception section, of whether or not a partial arithmetic operation result is outputted from an arithmetic operation unit of the own node; and a transmission section that transmits the OAM packet including the record made by the OAM processing section to another computation node, wherein the OAM processing section, depending on the state of the other computation node indicated by the OAM packet, causes the transmission section to transmit the partial arithmetic operation result stored in a storage unit to the other computation node.

### CROSS-REFERENCE TO RELATED APPLICATIONS

This application is a national phase entry of PCT Application No. PCT/JP2019/046967, filed on Dec. 2, 2019, which application is hereby incorporated herein by reference.

### TECHNICAL FIELD

Embodiments of the present invention relate to a distributed deep learning system and a distributed deep learning method and, more particularly, to a technology of distributed deep learning that is performed in a distributed and cooperative manner by a plurality of computation nodes that liaise with each other in a network.

### BACKGROUND

In recent years, sophistication of services and provision of added values have been actively pursued, with application of machine learning to various information and data. In many cases, machine learning for such situation requires large computational resources. In particular, in machine learning using a neural network, which is called deep learning, a large amount of training data needs to be processed in learning, which is a process of optimizing constituent parameters of the neural network. To speed up such learning processing, parallel processing using a plurality of arithmetic operation devices is one of solutions.

For example, Non-Patent Literature 1 discloses a distributed deep learning system in which four compute nodes are connected to an InfiniBand switch through an InfiniBand network. Each compute node includes four GPUs (Graphics Processing Units). In the distributed deep learning system disclosed in Non-Patent Literature 1, arithmetic operations for learning are executed by the four compute nodes in parallel, whereby speed is increased.

Non-Patent Literature 2 discloses a configuration in which one or more computation nodes (GPU server(s)) including eight GPUs is connected to an Ethernet® switch through an Ethernet network. Non-Patent Literature 2 discloses examples, for the number of computation nodes, in which 1, 2, 4, 8, 16, 32, and 44 computation nodes are used, respectively.

On the system disclosed in Non-Patent Literature 2, machine learning is performed by using distributed synchronous SGD (Stochastic Gradient Descent). Specifically, machine learning is performed according to a following procedure.

(1) Part of training data is sampled. A sampled training data set is referred to as a minibatch.

(2) The minibatch is partitioned into as many parts as the number of GPUs, and the parts are assigned to the GPUs, respectively.

(3) Each GPU calculates a loss function L(w) that is an indicator of how far an output value produced by the neural network when the training data assigned in (2) is inputted diverges from a correct answer (referred to as “teaching data”). Such a process of calculating the loss function is referred to as forward propagation because output values are computed in order from an input-side layer to an output-side layer of the neural network.

(4) Each GPU calculates a partial derivative (gradient) of the values of the loss function obtained in (3) with respect to each constituent parameter of the neural network (weight or the like of the neural network). In the process, the gradient is calculated for a constituent parameter of each layer in order from the output-side layer to the input-side layer of the neural network, and the process is therefore referred to as backpropagation.

(5) A mean of the gradients respectively obtained by the GPUs is computed.

(6) Each GPU updates each constituent parameter of the neural network by using the mean gradient calculated in (5) such that the loss function L(w) becomes smaller, by using SGD (Stochastic Gradient Descent). SGD is computational processing of making the loss function L(w) smaller by changing each constituent parameter value by a minor amount in a direction to the gradient. By iterating such processing, the neural network is updated to the neural network with the smaller loss functions L(w), that is, the neural network with high accuracy that produces outputs closer to correct answers.

Non-Patent Literature 3 discloses a distributed deep learning system with a configuration in which 128 computation nodes, each including eight GPUs, are connected to each other through an InfiniBand network.

All of the conventional distributed deep learning systems disclosed in Non-Patent Literatures 1 to 3 show that as the number of computation nodes increases, leaning speed increases, and learning time can be reduced. In such cases, since a mean of constituent parameter values of a neural network, such as a mean of gradients respectively calculated by computation nodes, is computed, computation such as the calculation of a mean value needs to be performed by transmitting and receiving such constituent parameters among the computation nodes.

On the other hand, when the number of nodes is increased to increase the number of parallel processing, required communication processing sharply increases. On a computation node, when arithmetic operation processing such as the computation of a mean value and processing for data transmission and reception are performed by using software as in the conventional technologies, a problem arises that overheads accompanying the communication processing are so large that it is difficult to sufficiently improve learning efficiency.

For example, Non-Patent Literature 3 discloses relations between a time period required for 100 iterations of learning processing, a communication time period in the time period for the iterations, and the number of GPUs. According to such relations, as the number of GPUs increases, the communication time period increases, and particularly the communication time period sharply increases at 512 GPUs or more.

### CITATION LIST

### Non-Patent Literature

Non-Patent Literature 1: Rengan Xu and Nishanth Dandapanthu., “Deep Learning Performance with P100 GPUs”, Dell EMC HPC Innovation Lab. October 2016, Internet <http://ja.community.dell.com/techcenter/m/mediagallery/3765/download>
Non-Patent Literature 2: Priya Goyal, Piotr Dollar, Ross Girshick, Pieter Noordhuis, Lukasz Wesolowski, Aapo Kyrola, Andrew Tulloch, Yangqing Jia, Kaiming He, “Accurate, Large Minibatch SGD: Training ImageNet in 1 Hour”, Cornell University Library, U.S., arXiv:1706.02677, 2017, Internet <https://arxiv.org/abs/1706.02677>
Non-Patent Literature 3: Takuya Akiba, Shuji Suzuki, Keisuke Fukuda, “Extremely Large Minibatch SGD: Training ResNet-50 on ImageNet in 15 Minutes”, Cornell University Library, U.S., arXiv:1711.04325, 2017, Internet <https://arxiv.org/abs/1711.04325>

### SUMMARY

### Technical Problem

However, the conventional distributed deep learning systems have a problem that as the number of computation nodes connected to a communication network increases, speedup of cooperative processing among the computation nodes is restrained.

Embodiments of the present invention have been made to solve the above problem, and an object of embodiments of the present invention is to perform cooperative processing among computation nodes at high speed even if the number of the computation nodes connected to a communication network increases.

### Means for Solving the Problem

To solve the problem, a distributed deep learning system according to embodiments of the present invention includes a plurality of computation nodes mutually connected through a communication network, wherein each of the plurality of computation nodes includes: an arithmetic operation device that performs computation for matrix multiplication included in arithmetic operation processing in a neural network, and outputs a first arithmetic operation result; a first storage device that stores the first arithmetic operation result outputted from the arithmetic operation device; and a network processing device including a first transmission circuit that transmits the first arithmetic operation result stored in the first storage device to another computation node, a first reception circuit that receives the first arithmetic operation result from the other computation node, an addition circuit that calculates a second arithmetic operation result that is a sum of the first arithmetic operation result stored in the first storage device and the first arithmetic operation result from the other computation node received by the first reception circuit, a second transmission circuit that transmits the second arithmetic operation result to the other computation node, a second reception circuit that receives the second arithmetic operation result from each of the other computation node, a third reception circuit that receives a notification packet indicating states of the plurality of computation nodes, an OAM processing circuit that makes a record, in the notification packet received by the third reception circuit, of whether or not the first arithmetic operation result is outputted from the arithmetic operation device of the own node, and a third transmission circuit that transmits the notification packet including the record made by the OAM processing circuit to the other computation node, wherein the OAM processing circuit, depending on the state of the other computation node indicated by the notification packet, causes the first transmission circuit to transmit the first arithmetic operation result stored in the first storage device to the other computation node.

To solve the problem, a distributed deep learning system according to embodiments of the present invention includes a plurality of computation nodes and a collection node mutually connected through a communication network, wherein each of the plurality of computation nodes includes: an arithmetic operation device that performs computation for matrix multiplication included in arithmetic operation processing in a neural network, and outputs a first arithmetic operation result; a first network processing device including a first transmission circuit that transmits the first arithmetic operation result outputted from the arithmetic operation device to the collection node, a first reception circuit that receives, from the collection node, a second arithmetic operation result that is a sum of the first arithmetic operation results computed at the plurality of computation nodes, a second reception circuit that receives a notification packet indicating states of the plurality of computation nodes, a first OAM processing circuit that makes a record, in the notification packet received by the second reception circuit, of whether or not the first arithmetic operation result is outputted from the arithmetic operation device of the own node, and a second transmission circuit that transmits the notification packet including the record made by the first OAM processing circuit to the collection node; and a first storage device that stores the second arithmetic operation result received by the first reception circuit, wherein the first OAM processing circuit, based on an instruction from the collection node, causes the first transmission circuit to transmit the first arithmetic operation result stored in the first storage device to the collection node, and wherein the collection node includes a second network processing device including a second OAM processing circuit that generates the notification packet, a third transmission circuit that transmits the generated notification packet to each of the plurality of computation nodes, a third reception circuit that receives, from each of the plurality of computation nodes, the notification packet including the record made by the first OAM processing circuit of each of the plurality of computation nodes, a fourth reception circuit that receives the first arithmetic operation results from the plurality of computation nodes, an addition circuit that calculates the second arithmetic operation result that is a sum of the first arithmetic operation results received by the fourth reception circuit, and a fourth transmission circuit that transmits the second arithmetic operation result obtained by the addition circuit to the plurality of computation nodes, wherein the second OAM processing circuit, depending on the states of the plurality of computation nodes indicated by the respective notification packets, instructs the plurality of computation nodes to transmit the first arithmetic operation result to the collection node, in order to collect the first arithmetic operation results obtained at the plurality of computation nodes.

To solve the problem, a distributed deep learning method according to embodiments of the present invention is a distributed deep learning method performed by a distributed deep learning system including a plurality of computation nodes mutually connected through a communication network, including: by each of the plurality of computation nodes, an arithmetic operation step of performing computation for matrix multiplication included in arithmetic operation processing in a neural network, and outputting a first arithmetic operation result; a first storage step of storing, in a first storage device, the first arithmetic operation result outputted in the arithmetic operation step; and a network processing step including, a first transmission step of transmitting the first arithmetic operation result stored in the first storage device to another computation node, a first reception step of receiving the first arithmetic operation result from the other computation node, an addition step of calculating a second arithmetic operation result that is a sum of the first arithmetic operation result stored in the first storage device and the first arithmetic operation result from the other computation node received in the first reception step, a second transmission step of transmitting the second arithmetic operation result to the other computation node, a second reception step of receiving the second arithmetic operation result from the other computation node, a third reception step of receiving a notification packet indicating states of the plurality of computation nodes, an OAM processing step of making a record, in the notification packet received in the third reception step, of whether or not the first arithmetic operation result is outputted in the arithmetic operation step at the own node, and a third transmission step of transmitting the notification packet including the record made in the OAM processing step to the other computation node, wherein the OAM processing step includes, depending on the state of the other computation node indicated by the notification packet, causing the first arithmetic operation result stored in the first storage device to be transmitted to the other computation node in the first transmission step.

To solve the problem, a distributed deep learning method according to embodiments of the present invention is a distributed deep learning method performed by a distributed deep learning system including a plurality of computation nodes and a collection node mutually connected through a communication network, including: by each of the plurality of computation nodes, an arithmetic operation step of performing computation for matrix multiplication included in arithmetic operation processing in a neural network, and outputting a first arithmetic operation result; a first network processing step including a first transmission step of transmitting the first arithmetic operation result outputted in the arithmetic operation step to the collection node, a first reception step of receiving, from the collection node, a second arithmetic operation result that is a sum of the first arithmetic operation results computed at the plurality of computation nodes, a second reception step of receiving a notification packet indicating states of the plurality of computation nodes, a first OAM processing step of making a record, in the notification packet received in the second reception step, of whether or not the first arithmetic operation result is outputted in the arithmetic operation step at the own node, and a second transmission step of transmitting the notification packet including the record made in the first OAM processing step to the collection node; and a first storage step of storing, in a first storage device, the second arithmetic operation result received in the first reception step, wherein the first OAM processing step includes, based on an instruction from the collection node, causing the first arithmetic operation result stored in the first storage device to be transmitted to the collection node in the first transmission step, and by the collection node, a second OAM processing step of generating the notification packet; and a second network processing step including a third transmission step of transmitting the generated notification packet to each of the plurality of computation nodes, a third reception step of receiving, from each of the plurality of computation nodes, the notification packet including the record made in the first OAM processing step at each of the plurality of computation nodes, a fourth reception step of receiving the first arithmetic operation results from the plurality of computation nodes, an addition step of calculating the second arithmetic operation result that is a sum of the first arithmetic operation results received in the fourth reception step, and a fourth transmission step of transmitting the second arithmetic operation result obtained in the addition step to the plurality of computation nodes, wherein the second OAM processing step includes, depending on the states of the plurality of computation nodes indicated by the respective notification packets, instructing the plurality of computation nodes to transmit the first arithmetic operation result to the collection node, in order to collect the first arithmetic operation results obtained at the plurality of computation nodes.

### Effects of Embodiments of the Invention

According to embodiments of the present invention, each of a plurality of computation nodes mutually connected through a communication network receives a notification packet that notifies states of the plurality of computation nodes, makes a record, in the received notification packet, of whether or not a first arithmetic operation result is outputted from an arithmetic operation device of the own node, and transmits the notification packet including the record to the other computation nodes. Accordingly, even if the number of computation nodes connected to the communication network increases, cooperative processing among the computation nodes can be performed at higher speed.

### BRIEF DESCRIPTION OF THE DRAWINGS

FIG. 1 is a block diagram showing a configuration of a distributed deep learning system according to a first embodiment of the present invention.

FIG. 2 is a diagram for describing learning processing of a neural network.

FIG. 3 is a diagram for describing an example of computation on hidden layers.

FIG. 4 is a diagram for describing an example of computation on hidden layers.

FIG. 5 is a diagram for describing weight parameters that are divided and stored among storage units of a plurality of computation nodes.

FIG. 6 is a block diagram showing a configuration of a computation node according to the first embodiment.

FIG. 7 is s schematic diagram showing examples of a configuration of an OAM packet according to the first embodiment.

FIG. 8 is a block diagram showing an example of a configuration of a computation node according to a conventional example.

FIG. 9 is a block diagram showing an example of a hardware configuration of the computation node according to the first embodiment.

FIG. 10 is a flowchart for describing operation of the computation node according to the first embodiment.

FIG. 11 is a sequence chart for describing operation in the distributed deep learning system according to the first embodiment.

FIG. 12 is a sequence chart for describing operation in the distributed deep learning system according to the first embodiment.

FIG. 13 is a sequence chart for describing operation in a distributed deep learning system according to a second embodiment.

FIG. 14 is a block diagram showing a configuration of a distributed deep learning system according to a third embodiment.

FIG. 15 is a block diagram showing a configuration of a collection node according to the third embodiment.

FIG. 16 is a block diagram showing an example of a hardware configuration of the collection node according to the third embodiment.

FIG. 17 is a sequence chart for describing operation in the distributed deep learning system according to the third embodiment.

FIG. 18 is a sequence chart for describing operation in the distributed deep learning system according to the third embodiment.

### DETAILED DESCRIPTION OF ILLUSTRATIVE EMBODIMENTS

Hereinafter, preferred embodiments of the present invention will be described in detail with reference to FIGS. 1 to 18.

### Outline of Embodiments of the Invention

First, an outline of a distributed deep learning system according to an embodiment of the present invention will be described with reference to FIGS. 1 to 5. As shown in FIG. 1, the distributed deep learning system according to the embodiment of the present invention includes a plurality of computation nodes 1-1 to 1-3 connected through a communication network. Each of the plurality of computation nodes 1-1 to 1-3 performs computation for part of matrix multiplication included in arithmetic operation processing in a neural network, and calculates a sum of a computation result of matrix multiplication computed by the own node and computation results of matrix multiplication received from the other computation nodes 1. Further, each of the plurality of computation nodes 1-1 to 1-3 distributes the calculated sum of the computation results of matrix multiplication to the other computation nodes 1.

In the distributed deep learning system according to the present embodiment, the computation nodes 1-1 to 1-3 share a notification packet that indicates states of the plurality of computation nodes 1-1 to 1-3, including information about whether or not computation for part of the matrix multiplication is performed by each of the plurality of computation nodes 1-1 to 1-3. Depending on the states of the computation nodes 1-1 to 1-3 indicated by the notification packet, each of the plurality of computation nodes 1-1 to 1-3 calculates the sum of the computation result of matrix multiplication computed by the own node and the computation results of matrix multiplication received from the other computation nodes 1. In the present embodiment, for the notification packet, an Operation Administration Maintenance (OAM) packet, which is used for operation, administration, and maintenance of a communication network, is utilized.

As described above, in the distributed deep learning system according to the present embodiment, by using a synchronization method using an OAM packet, addition processing is performed for the parts of matrix multiplication computed in a distributed manner by the computation nodes 1-1 to 1-3, respectively, and a result of the addition is distributed to the plurality of computation nodes 1-1 to 1-3. Moreover, another characteristic of the distributed deep learning system according to the present embodiment is that each of the plurality of computation nodes 1-1 to 1-3 includes an OAM processing circuit that processes an OAM packet, in a network processing device that controls data transmission and reception and communication.

Note that in a description below, the computation nodes 1-1 to 1-3 are collectively referred to as the computation node 1, in some cases. In each drawing including FIG. 1, to facilitate a description, a case is described in which the distributed deep learning system includes three computation nodes 1-1 to 1-3. However, any number N (N≥2) of computation nodes 1 may be used.

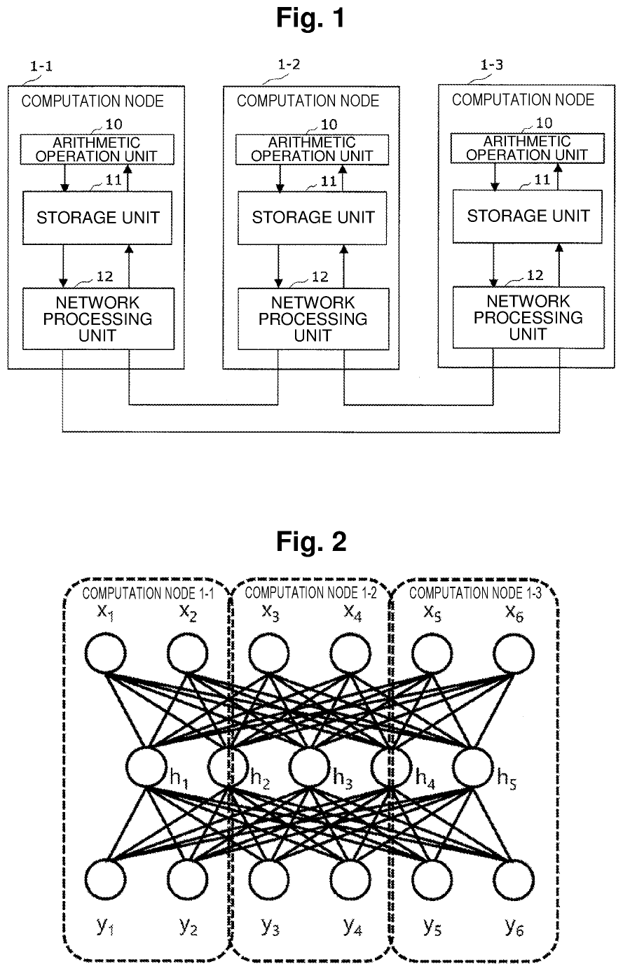

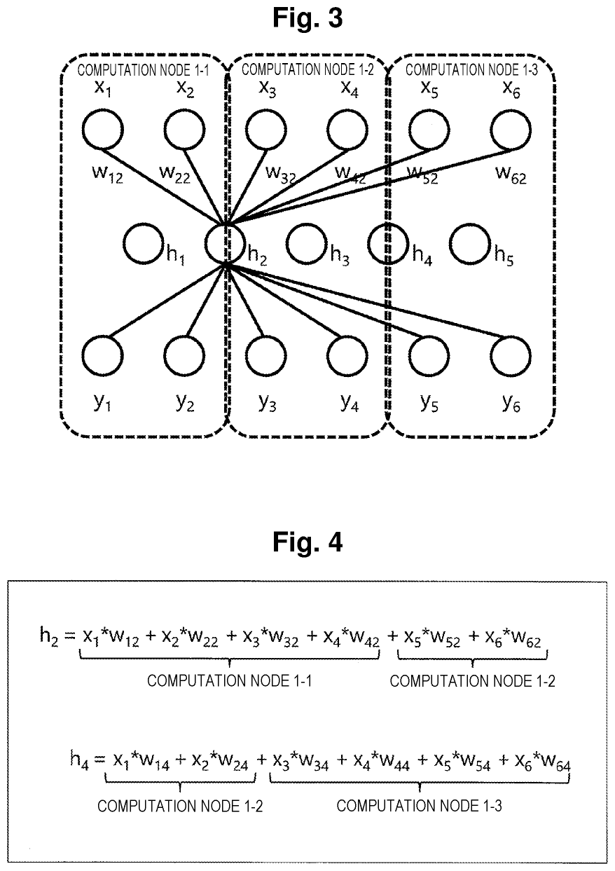

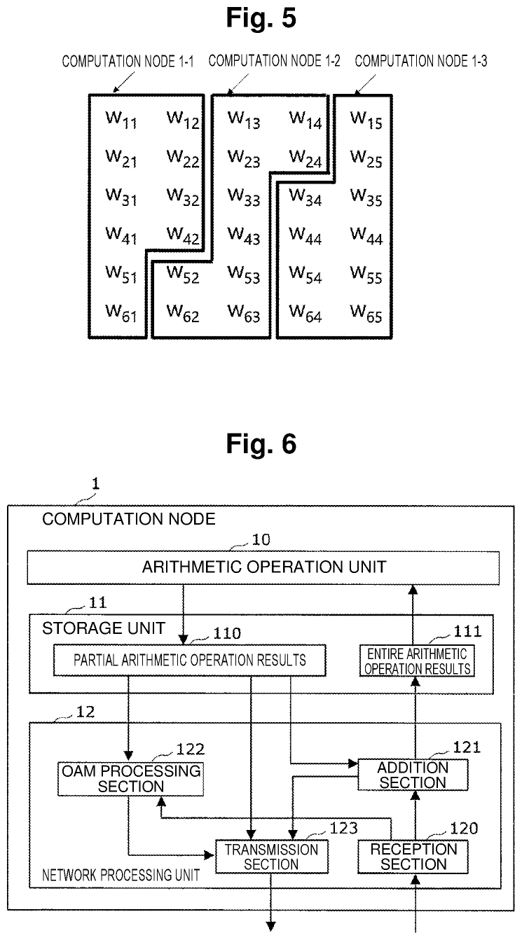

FIG. 2 shows an example of learning processing of a neural network, performed by using the distributed deep learning system according to an embodiment of the present invention. FIG. 3 shows an example of computation on hidden layers in the learning processing of the neural network, performed by using the distributed deep learning system according to an embodiment of the present invention. FIG. 4 shows an example in which computation on the hidden layers in the learning processing of the neural network, performed by using the distributed deep learning system according to an embodiment of the present invention, is divided and performed among a plurality of computation nodes. FIG. 5 shows an example in which weight parameters used when the learning processing of the neural network, performed by using the distributed deep learning system according to an embodiment of the present invention, are divided and stored among the plurality of computation nodes 1.

In the distributed deep learning system according to an embodiment of the present invention, training of the neural network to learn weight values, using training data in deep learning, is performed in the entire distributed deep learning system. Specifically, each computation node 1, which is a learning node, computes a gradient of weight data by performing predetermined arithmetic operation processing in the neural network by using the training data and the neural network. At a time point when the predetermined arithmetic operation is completed, each of the plurality of computation nodes 1 has the mutually different gradient of weight data.

For example, the network processing device, which can be implemented by using a computing interconnect device or the like connected to the communication network, collects the gradients of the weight data, performs processing of averaging the collected data, and distributes a result thereof to the computation nodes 1 again. Using the mean gradient of the weight data, each computation node 1 performs the predetermined arithmetic operation processing in the neural network again by using the training data and the neural network. Such processing is iterated, whereby the distributed deep learning system acquires a learned neural network model.

Each computation node 1 includes a learning function of computing an output value of the neural network, which is a mathematical model constructed with software, and further improving accuracy of output values by updating constituent parameters of the neural network based on the training data.

The neural network is constructed in each computation node 1. For a method for implementing the computation node 1, the computation node 1 may be implemented by software on a CPU or a GPU, or may be implemented by an LSI (Large Scale Integration) circuit formed on an FPGA (Field Programmable Gate Array) or an ASIC (Application Specific Integrated Circuit). A specific example of a hardware configuration of the computation node 1 will be described later.

FIG. 2 illustrates a case in which outputs y₁ to y₆ are obtained by computing hidden layers (h₁ to h₅) for inputs x₁ to x₆ by using the three computation nodes 1-1 to 1-3 included in the distributed deep learning system. In the example in FIG. 2, a model parallel scheme is shown in which a neural network model is divided among the plurality of computation nodes 1. In general, the scheme is adopted when such a large-scale neural network that one computation node 1 cannot accommodate weight parameters is trained.

As shown in FIG. 3, when an output of a hidden layer is obtained, a weight (w) is involved as a parameter representing a degree of closeness of a relation between an input x and the hidden layer h, and outputs of the hidden layer h are obtained by performing a product-sum operation on inputs x and weights w. For example, when outputs of a hidden layer h₂ are obtained, a product-sum operation on inputs x₁ to x₆ and weights w₁₂ to w₆₂ is performed, whereby outputs of the hidden layer h₂ are obtained.

When the model parallel scheme of dividing a neural network model among a plurality of computation nodes 1 is used as described earlier, specifically as shown in FIG. 4, the outputs of the hidden layer h₂ are computed across the computation node 1-1 and the computation node 1-2. The outputs of the hidden layer h₂ are computed by adding up results computed by each of the computation nodes 1-1, 1-2. At the time, to add up the results computed by each computation node 1, collective communication is performed. An object of embodiments of the present invention is to speed up the collective communication.

In the present description, a result of the computation, by each computation node 1, for part of the matrix multiplication included in the arithmetic operation processing in the neural network is referred to as “partial arithmetic operation result” (first arithmetic operation result), and a sum of the partial arithmetic operation results is referred to as “entire arithmetic operation result” (second arithmetic operation result).

Similarly, outputs of a hidden layer h₄ are computed across the computation node 1-2 and the computation node 1-3. For outputs of hidden layers h₁, h₃, h₅, computation is completed without involving a plurality of computation nodes 1.

FIG. 5 shows weight parameters w retained by the plurality of computation nodes 1-1 to 1-3. The number of weight parameters w that can be retained by each of the computation nodes 1-1 to 1-3 is determined depending on an available memory capacity included in each of the computation nodes 1-1 to 1-3. Accordingly, as the neural network has a larger model size, the number of weight parameters w also increases, and the weight parameters w of the entire neural network cannot be retained by each of the computation nodes 1-1 to 1-3, in some cases. In such a case, as shown in FIG. 5, weight parameters w₁ to w₆₅ of the neural network to be trained are divided and retained among the computation nodes 1-1 to 1-3.

### First Embodiment

Next, a distributed deep learning system according to a first embodiment of the present invention will be described.

As shown in FIG. 1, the distributed deep learning system includes a plurality of computation nodes 1-1 to 1-3. The plurality of computation nodes 1-1 to 1-3 are connected by a ring-shaped communication network. The plurality of computation nodes 1-1 to 1-3 according to the present embodiment can be connected by the communication network that is capable of bi-directional communication.

### Functional Blocks of the Computation Node

As shown in FIGS. 1 and 6, each of the computation nodes 1-1 to 1-3 includes an arithmetic operation unit (arithmetic operation device) 10, a storage unit (first storage device, second storage device) 11, and a network processing unit (network processing device) 12.

The arithmetic operation unit 10 performed computation for part of matrix multiplication in a neural network and outputs a partial arithmetic operation result. As described with FIGS. 4 and 5, the arithmetic operation unit 10 performs computation for a matrix multiplication of weight parameters w of the neural network that the own node retains and inputs x or outputs of each hidden layer h. Outputs of the hidden layers h are an entire arithmetic operation result 111 stored in the storage unit 11, and are shared with the other computation nodes 1.

The storage unit 11 includes an area in which partial arithmetic operation results (first storage device) 110 are stored and an area in which entire arithmetic operation results (second storage device) 111 are stored. Moreover, the storage unit 11 stores some weight parameters w of the weight parameters w of the neural network.

The partial arithmetic operation results 110 store the partial arithmetic operation result outputted from the arithmetic operation unit 10.

The entire arithmetic operation results 111 store the entire arithmetic operation result obtained by the own node, and the entire arithmetic operation results received from the other computation nodes 1.

The network processing unit 12 includes a reception section (first reception circuit, second reception circuit, third reception circuit) 120, an addition section (addition circuit) 121, an OAM processing section (OAM processing circuit) 122, and a transmission section (first transmission circuit, second transmission circuit, third transmission circuit) 123.

The reception section 120 receives the partial arithmetic operation results from the other computation nodes 1 through the communication network. The reception section 120 receives the entire arithmetic operation results from the other computation nodes 1. The reception section 120 receives an OAM packet that indicates states of the computation nodes 1-1 to 1-3 and is shared among the plurality of computation nodes 1-1 to 1-3. For example, the reception section 120 can receive an OAM packet issued by another arbitrarily designated computation node 1 serving as a starting point.

The addition section 121 calculates the entire arithmetic operation result by adding the partial arithmetic operation result from another computation node 1 received by the reception section 120 and the partial arithmetic operation result computed by the own node. The addition section 121 can be configured by using, for example, an addition circuit using a logic circuit. The entire arithmetic operation result obtained by the addition section 121 is stored in the storage unit 11.

The OAM processing section 122 makes a record, in the OAM packet received by the reception section 120, of whether or not the partial arithmetic operation result is outputted by the arithmetic operation unit 10 of the own node. When the own node is designated as a master node that controls the other computation nodes 1, the OAM processing section 122 generates an OAM packet at a constant cycle, and transmits the OAM packet to the other computation nodes 1.

In general, OAM includes a function of assisting operation, administration, and maintenance of Ethernet, and is used as a protocol for network establishment, monitoring, and the like. For example, such protocols include a protocol standardized by IEEE, ITU-T, or MEF, a vendor-specific protocol, or the like.

For example, when the partial arithmetic operation result has been calculated by the arithmetic operation unit 10 of the own node, the OAM processing section 122 sets a flag by setting a value of a predetermined bit in the OAM packet to “1”.

Moreover, depending on the state of another computation node 1 indicated by the OAM packet from the other computation nodes 1 received by the reception section 120, the OAM processing section 122 causes the transmission section 123 to transmit the partial arithmetic operation result computed at the own node to the another computation node 1. For example, when the OAM processing section 122 detects, from flag values in the OAM packet, that the partial arithmetic operation results are outputted at all of the other computation nodes 1, the OAM processing section 122 can determine completion of synchronization.

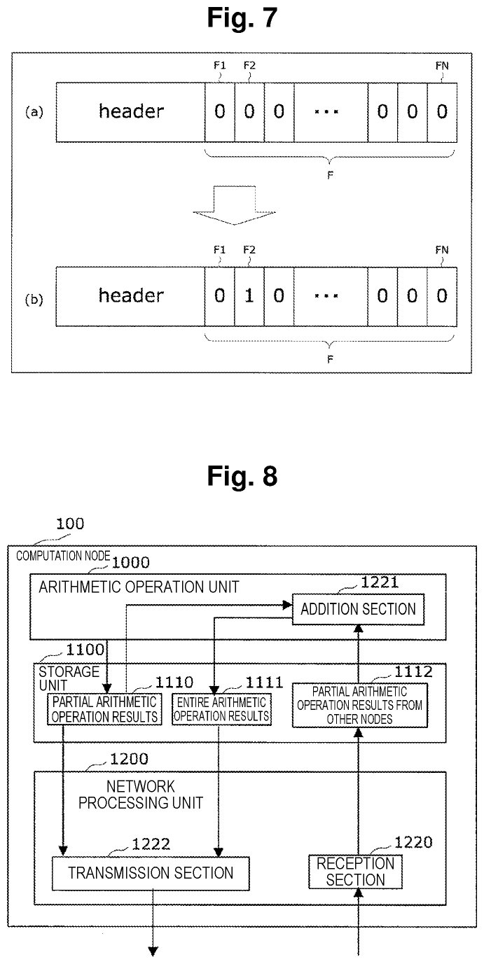

FIG. 7 is s schematic diagram showing examples of a configuration of an OAM packet according to the present embodiment. As shown by (a) and (b) in FIG. 7, the OAM packet includes flags F (F1, F2, . . . , FN (N□2)) in which each bit indicates a completed or non-completed state of the partial arithmetic operation for each computation node 1, respectively. The OAM packet shown by (a) in FIG. 7 is generated, for example, by an arbitrary computation node 1 serving as a master node, among the plurality of computation nodes 1.

In such a case, a computation node 1 that is a slave node sets “1”, which is a value indicating “completion”, at a bit location for the own node in the received OAM packet when the partial arithmetic operation is completed at the own node. In the OAM packet shown by (b) in FIG. 7, a value of the flag F2 is “1”, which indicates that the partial arithmetic operation is completed at the second computation node 1-2 that is a slave node, among the computation nodes 1-1, . . . , 1-N.

The transmission section 123 transmits the partial arithmetic operation result computed by the arithmetic operation unit 10 of the own node and stored in the storage unit 11, to the another computation node 1 through the communication network. The transmission section 123 distributes the entire arithmetic operation result obtained by the addition section 121 to the other computation nodes 1 through the communication network. The transmission section 123 transmits the OAM packet processed by the OAM processing section 122 to the other computation nodes 1.

Note that each of the plurality of computation nodes 1-1 to 1-3 includes similar functional configurations.

Here, a description will be given by comparing the configuration of the computation node 1 included in the distributed deep learning system according to the present embodiment and an example of a configuration of a computation node 100 included in a general distributed deep learning system as shown in FIG. 8.

The computation node 100 shown in FIG. 8 includes an arithmetic operation unit 1000, a storage unit 1100, and a network processing unit 1200. As described with FIGS. 1 and 6, the computation node 1 in the present embodiment includes the OAM processing section 122 that processes an OAM packet and the addition section 121 that calculates a sum of the partial arithmetic operation result received by the network processing unit 12 from another computation node 1 and the partial arithmetic operation result computed at the own node.

However, in the general computation node 100 shown in FIG. 8, the arithmetic operation unit 1000 includes an addition section 1221, and a component corresponding to the OAM processing section 122 is not included.

Moreover, in the computation node 100 shown in FIG. 8, the addition section 121 provided to the arithmetic operation unit 1000 consumes additional memory access time to access a memory included in the storage unit 1100, to calculate an entire arithmetic operation result. In a distributed deep learning system including a plurality of such computation nodes woo, as described above, the arithmetic operation unit 1000 of each computation node woo needs to calculate an entire arithmetic operation result. Accordingly, an entire processing time period is long, compared to the configuration according to the present embodiment.

As described above, the network processing unit 12 included in each of the computation nodes 1-1 to 1-3 according to the present embodiment includes the OAM processing section 122, which processes an OAM packet that notifies states of the computation nodes 1 and is shared among all of the computation nodes 1-1 to 1-3. Each computation node 1 detects, from flag values in the OAM packet, completion of the partial arithmetic operation, that is, completion of synchronization, by any other computation node 1 that is needed for the entire arithmetic operation.

A computation node 1 starts collective communication, including execution of the entire arithmetic operation and distribution of the entire arithmetic operation result, as long as the partial arithmetic operation is completed by a specified computation node 1 with which the collective communication is performed. Accordingly, it becomes unnecessary for the arithmetic operation unit 10 of each and every computation node 1 to perform the entire arithmetic operation, and accompanying memory reading and writing can be reduced. Moreover, since a sum of the partial arithmetic operation result received from the other computation node 1 and the partial arithmetic operation result computed at the own node is computed by the addition section 121 provided to the network processing unit 12, additional memory access time, which occurs in the computation node 100 in FIG. 8, does not occur.

### Hardware Configuration of the Computation Node

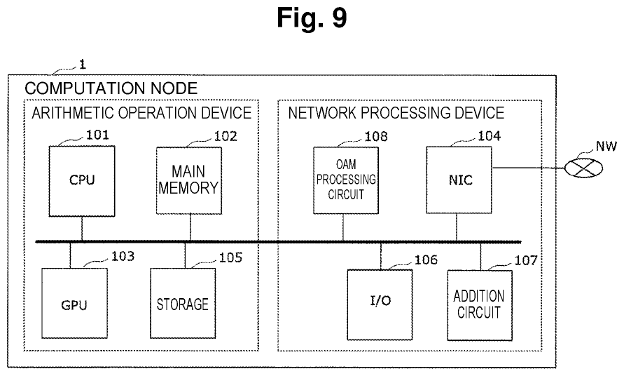

Next, an example of the hardware configuration implementing the computation node 1 including the above-described functions will be described with reference to a block diagram in FIG. 9.

As shown in FIG. 9, the computation node 1 can be implemented, for example, by a computer including a CPU 101, a main memory 102, a GPU 103, an NIC 104, a storage 105, and an I/O 106, and a program that controls such hardware resources.

The main memory 102 stores beforehand a program for causing the CPU 101 and the GPU 103 to perform various control and arithmetic operations. The functions of the computation node 1, such as the arithmetic operation unit 10, the addition section 121, and the OAM processing section 122 shown in FIGS. 1 and 6, are implemented by the CPU 101, the GPU 103, and the main memory 102.

The NIC 104 is an interface circuit for providing network connection between the computation nodes 1 and with various external electronic devices. The NIC 104 implements the reception section 120 and the transmission section 123 in FIG. 6. For the NIC 104, for example, an inter-device interface that supports 100 Gbit Ethernet® communication can be used.

The storage 105 includes a readable-writable recording medium and a drive device for reading from and writing into the recording medium various information such as a program and data. For the storage 105, a hard disk as a recording medium or a semiconductor memory such as a flash memory can be used. The storage 105 implements the storage unit 11 described with FIGS. 1 and 6.

The storage 105 includes a program storage area in which a program for causing the computation node 1 to perform distributed deep learning processing, such as arithmetic operations in the neural network including the matrix multiplication, and OAM packet processing, is stored. The storage 105 may include a backup area for backing up, for example, the above-mentioned data and program.

The I/O 106 includes a network port that receives a signal from an external device as input and outputs a signal to an external device. For the network port, for example, two or more network ports can be used.

For an addition circuit 107, for example, an addition circuit including a basic logic gate, or the like can be used. The addition circuit 107 implements the addition section 121 described with FIG. 6. In the present embodiment, the addition circuit 107 is provided to the network processing device including the NIC 104 and the I/O 106. The arithmetic operation device includes the CPU 101, the main memory 102, the GPU 103, and the storage 105.

An OAM processing circuit 108 is implemented by, for example, a complex logic gate built by combining basic logic gates, or the like. Alternatively, the OAM processing circuit 108 can be implemented as a dedicated circuit such as an ASIC, or as a combination of an electric circuit and a program. In the present embodiment, similarly to the addition circuit 107, the OAM processing circuit 108 is provided to the transmission path-side network processing device including the NIC 104 and the I/O 106.

For the communication network NW according to the present embodiment, for example, a broadband network such as 100 Gbit Ethernet is used.

### Operation of the Computation Node

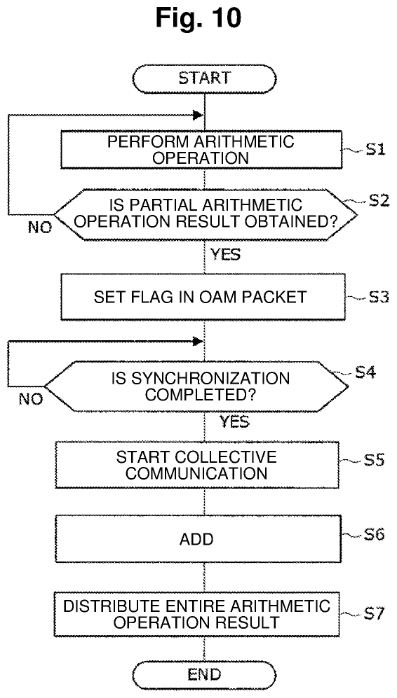

First, operation of each computation node 1 with the above-described components will be described by using a flowchart in FIG. 10. In the following, a neural network model, inputs x, and part of weight parameters w are loaded beforehand into the storage unit 11.

First, the arithmetic operation unit 10 performs computation for part of the matrix multiplication in training of the neural network (step S1).

Next, when a partial arithmetic operation result obtained by the arithmetic operation unit 10 is stored in the storage unit 11 (step S2: YES), the OAM processing section 122 sets a flag in an OAM packet received by the reception section 120 from one of the other computation nodes 1 (step S3). When a partial arithmetic operation result computed at the own node is not obtained (step S2: NO), the arithmetic operation in step S1 is performed (step S1). In such a case, the OAM processing section 122, even if an OAM packet is received by the reception section 120 from the one of the other computation nodes 1, does not set a flag and transfers the OAM packet to one of the other computation nodes 1.

Next, from values of the respective flags for the computation nodes 1 indicated by the OAM packet received by the reception section 120, the OAM processing section 122 detects completion of the partial arithmetic operation by another computation node 1 that is involved with collective communication to be performed with the own node, and on an occasion when synchronization is completed (step S4: YES), the network processing unit 12 starts the collective communication (step S5).

For example, the OAM processing section 122 can start the collective communication, based on an instruction to start the collective communication from a computation node 1 designated as a master node.

As described above, the distributed deep learning system is an OAM packet-based synchronized system, and for example, depending on flag states in an OAM packet indicating that the partial arithmetic operations are completed at all of the computation nodes 1-1 to 1-3, each computation node 1 can share the partial arithmetic operation result obtained by the own node with the other computation nodes 1 by performing collective communication. In such a case, each of the computation nodes 1-1 to 1-3 stores the partial arithmetic operation result computed by the own node in the storage unit 11 until the flag values in the OAM packet received at a constant cycle indicate that the partial arithmetic operations are completed at all of the computation nodes 1-1 to 1-3.

Note that even in the synchronized system, it is not necessary to wait until computation by the arithmetic operation unit 10 is completed at all of the computation nodes 1-1 to 1-3, and for example, completion of the partial arithmetic operations by some computation nodes 1 included in the distributed deep learning system may be an occasion, depending on the states in the OAM packet, in some cases.

For example, in the examples shown in FIGS. 2 to 5, since h₂ can be calculated when computation is completed at the computation node 1-1 and the computation node 1-2, collective communication may be started without waiting for completion of computation at the computation node 1-3, in some cases.

In step S5, when the network processing unit 12 starts the collective communication, the transmission section 123 transmits the partial arithmetic operation result computed at the own node to the other computation node or nodes 1 through the communication network. The reception section 120 receives the partial arithmetic operation result or results computed by the other computation node or nodes 1. At the time, as shown in FIG. 1, the transmission section 123 transmits the partial arithmetic operation result to a predetermined one of the other computation nodes 1 as a destination. The reception section 120 receives the partial arithmetic operation result or results from a predetermined one of the other computation nodes 1 connected in the network.

Next, the addition section 121 calculates an entire arithmetic operation result that is a sum of the partial arithmetic operation result obtained by the own node and the partial arithmetic operation result or results received from the other computation node or nodes 1 (step S6).

Next, the network processing unit 12 distributes the entire arithmetic operation result obtained in step S6 to the other computation nodes 1 (step S7). Specifically, the transmission section 123 transmits the entire arithmetic operation result obtained by the addition section 121 to the other computation nodes 1 through the communication network. Thereafter, the entire arithmetic operation result that is a sum of the partial arithmetic operation results computed by the plurality of computation nodes 1-1 to 1-3 is stored in the storage unit 11.

### Operation in the Distributed Deep Learning System

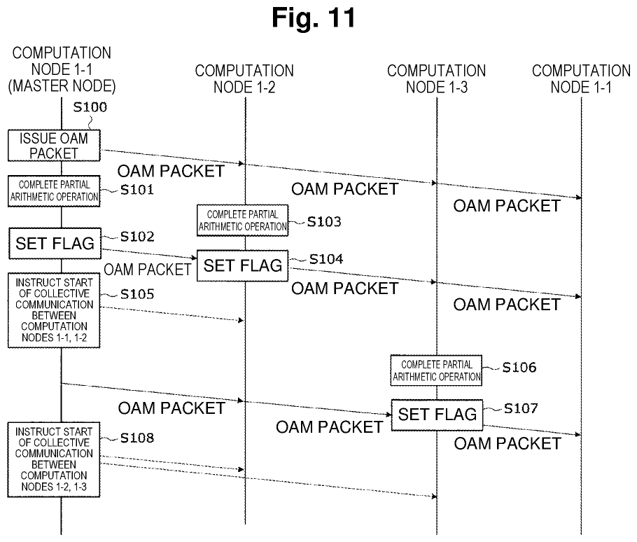

Next, operation in the distributed deep learning system will be described with reference to a sequence chart in FIG. 11. In the following, a description will be given by taking a case, as an example, in which the computation node 1-1 is a master node that issues an OAM packet at a constant cycle and instructs start of collective communication, and the computation nodes 1-2, 1-3 are slave nodes.

As described with FIG. 5, the computation node 1-1 retains the weight parameters w₁₂ to w₄₂ that represent connections between the inputs x₁ to x₄ and the hidden layer h₂. On the other hand, the computation node 1-2 retains the weight parameters w₅₂, w₆₂ between the other inputs x₅, x₆ and the hidden layer h₂. Accordingly, by the partial arithmetic operations for the computation nodes 1-1, 1-2 being completed, the entire arithmetic operation to obtain outputs of the hidden layer h₂ can be performed.

Similarly, as described with FIG. 5, the computation node 1-2 retains the weight parameters w₁₄ to w₂₄ that represent connections between the inputs x₁ to x₂ and the hidden layer h₄. On the other hand, the computation node 1-3 retains the weight parameters w₃₄ to w₆₄ between the other inputs x₃ to x₆ and the hidden layer h₄. Accordingly, by the partial arithmetic operations for the computation nodes 1-2, 1-3 being completed, the entire arithmetic operation to obtain outputs of the hidden layer h₄ can be performed.

As shown in FIG. 11, at the computation node 1-1, the OAM processing section 122 generates an OAM packet, and the transmission section 123 transmits the generated OAM packet to the other computation nodes 1-2, 1-3 (step S100). The OAM packet generated and issued by the computation node 1-1 is transferred, for example, in the order of the computation nodes 1-2, 1-3. Next, at the computation node 1-1, when the partial arithmetic operation is completed by the arithmetic operation unit 10 of the own node (step S101), the OAM processing section 122 sets a flag at a predetermined bit in the OAM packet (step S102). The transmission section 123 of the computation node 1-1 transmits the flagged OAM packet to the adjacent computation node 1-2.

Thereafter, the computation node 1-2 completes the partial arithmetic operation for the own node (step S103). At the computation node 1-2, the storage unit 11 stores a partial arithmetic operation result. Next, the OAM processing section 122 of the computation node 1-2 sets a flag indicating completion of the partial arithmetic operation for the own node, at a predetermined bit in the OAM packet transmitted from the computation node 1-1 (step S104). At the computation node 1-2, the transmission section 123 transmits the flagged OAM packet to the computation node 1-3. At the time, in the OAM packet, the flags indicating that the partial arithmetic operations are completed by the computation node 1-1 and the computation node 1-2 are set.

Thereafter, the OAM processing section 122 of the computation node 1-1, which is the master node, issues an instruction to start collective communication between the computation nodes 1-1, 1-2, based on the flag states in the returned OAM packet (step S105). When the computation node 1-2 receives the instruction, for example, at the computation node 1-2, the transmission section 123 transmits the partial arithmetic operation result obtained at the own node to the computation node 1-1, and at the computation node 1-1, the addition section 121 performs the entire arithmetic operation by adding up the partial arithmetic operation results obtained at the own node and the computation node 1-2. The computation node 1-1 distributes an entire arithmetic operation result to the other computation nodes 1-2, 1-3.

Thereafter, the OAM processing section 122 of the computation node 1-1, which is the master node, further transmits the OAM packet to the other computation nodes 1-2, 1-3. Next, the arithmetic operation unit 10 of the computation node 1-3 completes the partial arithmetic operation for the own node (step S106). At the computation node 1-3, the storage unit 11 stores a partial arithmetic operation result. Thereafter, when the computation node 1-3 receives the OAM packet, the OAM processing section 122 sets a flag indicating completion of the partial arithmetic operation for the own node (step S107). Thereafter, the transmission section 123 of the computation node 1-3 transmits the flagged OAM packet to the computation node 1-1 and the computation node 1-2.

The computation node 1-1, which is the master node, receives the OAM packet, and the OAM processing section 122 issues an instruction to start collective communication to the computation nodes 1-2, 1-3, based on the flag states in the OAM packet (step S108). Thereafter, the computation nodes 1-2, 1-3 that have received the instruction perform the entire arithmetic operations, and distribute obtained entire arithmetic operation results to the computation nodes 1-1 to 1-3.

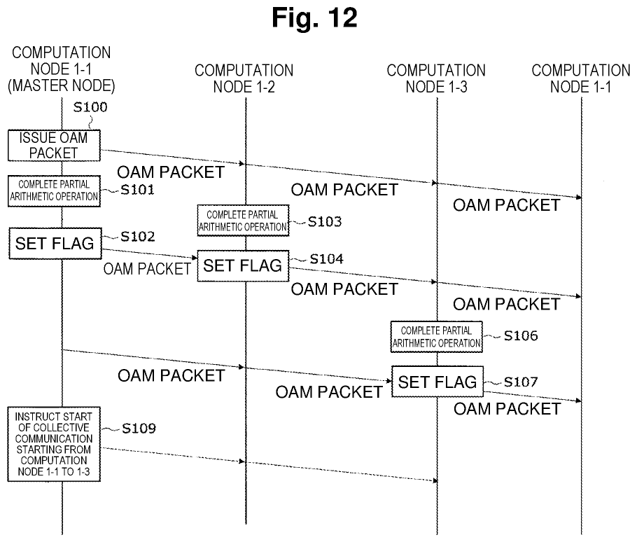

Next, a description will be given of operation in a case where in the distributed deep learning system according to the present embodiment, collective communication is started after the partial arithmetic operations are completed by all of the computation nodes 1-1 to 1-3, with reference to a sequence chart in FIG. 12.

As shown in FIG. 12, at the computation node 1-1, the OAM processing section 122 generates an OAM packet, and the transmission section 123 transmits the generated OAM packet to the other computation nodes 1-2, 1-3 (step S100). Thereafter, at the computation node 1-1, when the partial arithmetic operation is completed by the arithmetic operation unit 10 of the own node (step S101), the OAM processing section 122 of the computation node 1-1 sets a flag at a predetermined bit in the OAM packet (step S102). At the computation node 1-1, the transmission section 123 transmits the flagged OAM packet to the other computation nodes 1-2, 1-3.

Thereafter, the computation node 1-2 completes the partial arithmetic operation for the own node (step S103). At the computation node 1-2, the storage unit 11 stores a partial arithmetic operation result. Next, the OAM processing section 122 of the computation node 1-2 sets a flag indicating completion of the partial arithmetic operation for the own node, at a predetermined bit in the OAM packet transmitted from the computation node 1-1 (step S104). At the computation node 1-2, the transmission section 123 transmits the flagged OAM packet to the computation node 1-3. In the OAM packet at the time, the flags indicating that the partial arithmetic operations are completed at the computation node 1-1 and the computation node 1-2 are set.

Thereafter, the computation node 1-1, which is the master node, receives the OAM packet in which flag values are set and states are recorded, and further transfers the OAM packet to the other computation nodes 1-2, 1-3.

Thereafter, the arithmetic operation unit 10 of the computation node 1-3 completes the partial arithmetic operation for the own node (step S106). At the computation node 1-3, the storage unit 11 stores a partial arithmetic operation result. Thereafter, when the computation node 1-3 receives the OAM packet, the OAM processing section 122 sets a flag indicating completion of the partial arithmetic operation for the own node (step S107). Thereafter, the transmission section 123 of the computation node 1-3 transmits the flagged OAM packet to the computation node 1-1 and the computation node 1-2.

The computation node 1-1, which is the master node, receives the OAM packet, and the OAM processing section 122 detects, from the flag states in the OAM packet, that the partial arithmetic operations are completed at the computation nodes 1-1 to 1-3. On an occasion when the partial arithmetic operations are completed at all of the computation nodes 1-1 to 1-3, the computation node 1-1 issues an instruction to start collective communication among the computation nodes 1-1 to 1-3 (step S109). Thereafter, the computation nodes 1-1 to 1-3 each perform the entire arithmetic operation and distribute an obtained entire arithmetic operation result to the computation nodes 1-1 to 1-3.

Note that in the present embodiment, to share the partial arithmetic operation results, the transmission section 123 can transmit the partial arithmetic operation result computed at the own node to the other computation nodes 1, and the reception section 120 can receive the partial arithmetic operation results from the other computation nodes 1, by using communication packets. In such a case, the communication packets include an identifier for determining whether or not a partial arithmetic operation result is directed to the own node.

For example, in a header of a communication packet including a partial arithmetic operation result, flags are set or are not set at bit locations that are different among the computation node 1-1 to 1-3, whereby it can be determined whether or not data is directed to the own node. When the flag is set at the bit location for the own node in the header of the communication packet received by the reception section 120, it is determined that the partial arithmetic operation result included in the received communication packet is data directed to the own node. Then, the entire arithmetic operation result is calculated, which is a sum of the partial arithmetic operation result computed at the own and the received partial arithmetic operation results from the other computation nodes 1.

Note that the present embodiment is not limited to a case in which each of the computation nodes 1-1 to 1-3 transmits the partial arithmetic operation result outputted from the arithmetic operation unit 10 of the own node to the other computation nodes 1, based on flag values indicated by the OAM packet received by the own node. For example, each computation node 1 can be configured such that the arithmetic operation unit 10 of the own node starts the partial arithmetic operation, based on flag values indicated by the received OAM packet.

As described above, according to the first embodiment, through a synchronization process using an OAM packet shared among all of the computation nodes 1, on an occasion when the partial arithmetic operations are completed, each computation node 1 transmits a partial arithmetic operation result obtained by performing computation for part of the matrix multiplication in computation in the neural network to the other computation nodes 1. Each computation node 1 calculates an entire arithmetic operation result, which is a sum of the partial arithmetic operation results received from the other computation nodes 1 and the partial arithmetic operation result computed at the own node, and further distributes the entire arithmetic operation result to the other computation nodes 1.

According to the first embodiment, the network processing unit 12 is configured to include a function of computing an entire arithmetic operation result in a series of such processing, whereby it becomes unnecessary for the arithmetic operation unit 10 of each computation node 1 to perform the entire arithmetic operation, and accompanying memory reading and writing can be reduced. Accordingly, learning processing can be sped up, and even if the number of computation nodes connected to the communication network increases, the cooperative processing among the computation nodes can be performed at higher speed.

According to the first embodiment, since collective communication can be started between computation nodes 1 as long as the partial arithmetic operations are completed only by the computation nodes 1 that perform the collective communication, the distributed deep learning processing can be further sped up.

According to the first embodiment, the network processing unit 12 of each computation node 1 includes the OAM processing section 122, which performs OAM packet processing, including setting a flag in an OAM packet and reading the OAM packet. Accordingly, since the processing can be performed without copying the OAM packet in the storage unit 11, a delay in the processing can be reduced.

According to the first embodiment, it is not necessary for the arithmetic operation unit 10 to perform an addition operation, and accompanying memory reading and writing can be reduced. Accordingly, even if the number of computation nodes 1 connected to the communication network increases, the cooperative processing among the computation nodes 1 can be performed at higher speed.

### Second Embodiment

Next, a second embodiment of the present invention will be described. In a description below, the same components as in the first embodiment are denoted by the same reference signs, and a description thereof is omitted. A configuration of a distributed deep learning system and a configuration of each computation node 1 according to the present embodiment are similar to those of the first embodiment described with FIGS. 1 and 6.

In the first embodiment, the arbitrary computation node 1-1 serves as a start point to issue an OAM packet and read the OAM packet in which the other computation nodes 1-2, 1-3 record the respective states and set respective flags. In the first embodiment, a case is described in which depending on the states in the OAM packet, the computation node 1-1 instructs the computation nodes 1-2, 1-3 to start collective communication. On the other hand, in the second embodiment, the computation node 1-1 designated as a master node notifies, to each computation node 1, specification information that specifies, among the plurality of computation nodes 1-1 to 1-3, a specified computation node 1 to be involved with collective communication (hereinafter, referred to as “division information” on a model).

For example, as shown in FIG. 4, when the outputs of the hidden layer h₂ are obtained as an entire arithmetic operation result, the outputs can be computed if a partial arithmetic operation result by the computation node 1-1 and a partial arithmetic operation result by the computation node 1-2 are obtained. As described above, the division information (specification information) is information indicating which computation nodes 1 are required to complete partial arithmetic operations, to be able to start collective communication. For example, for the division information, respective unique IDs to the computation nodes 1 can be used.

The OAM processing section 122 of the computation node 1-1 designated as the master node stores the division information. At the computation nodes 1-2, 1-3 that receive the division information from the master node, issuance of an OAM packet and setting of a flag upon completion of obtaining a partial arithmetic operation result is performed between the computation nodes 1-2, 1-3, based on the division information.

More specifically, the division information from the master node is transmitted from the transmission section 123 (fourth transmission circuit) to the other computation nodes 1. At any one node of the computation nodes 1 designated as slave nodes that have received the division information by using the reception section 120 (fifth reception circuit), the OAM processing section 12 generates an OAM packet when the received division information includes the own node. Further, at the computation node 1 that has generated the OAM packet, the OAM processing section 122 causes the transmission section 123 to transmit the OAM packet to another computation node 1 involved with collective communication specified by the division information.

Regarding a computation node 1 to generate and issue an OAM packet, a configuration may be made such that a computation node 1 with the smallest or largest ID value among ID values indicated by the division information, or a computation node 1 that is the first to complete the partial arithmetic operation, issues an OAM packet.

The OAM processing section 122 sets a flag in the OAM packet when the arithmetic operation unit 10 of the own node completes the partial arithmetic operation.

### Sequence of Operation in the Distributed Deep Learning System

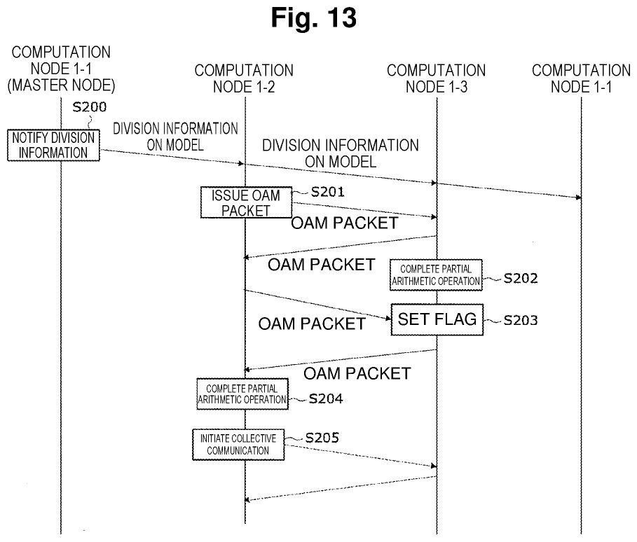

FIG. 13 is a sequence chart of operation in the distributed deep learning system according to the present embodiment. In the following, a description will be given of a case in which the computation node 1-1 is designated as a master node, and the computation nodes 1-2, 1-3 are slave nodes. The network processing unit 12 of the master node is assumed to store division information indicating which computation nodes 1 perform collective communication. Moreover, in the following, a description will be given of a case in which a computation node 1 assigned the smallest ID value issues an OAM packet according to the division information, and an ID value assigned to the computation node 1-2 is assumed to be smaller than an ID value assigned to the computation node 1-3.

First, the transmission section 123 of the computation node 1-1 designated as the master node transmits division information generated by the OAM processing section 122 to the other computation nodes 1-2, 1-3 (step S200). The division information is information that specifies, among the plurality of computation nodes 1-1 to 1-3, specified computation nodes 1 that are to output a plurality of partial arithmetic operation results required for the addition section 121 to perform a specified entire arithmetic operation.

Next, at the computation node 1-2 with the smallest ID value among ID values included in the division information, the OAM processing section 122 of the own node generates an OAM packet, and the OAM packet is transmitted to the other computation node 1-3 that is the other party involved with collective communication (step S201).

Thereafter, at the computation node 1-3, the arithmetic operation unit 10 of the own node completes the partial arithmetic operation (step S202). At the computation node 1-3, when the OAM packet is received, the OAM processing section 122 sets a flag by setting a value of a predetermined bit in the OAM packet to “1” (step S203).

Next, the transmission section 123 of the computation node 1-3 transmits the flagged OAM packet to the computation node 1-2 that is the other end of the collective communication, based on the division information. Thereafter, the arithmetic operation unit 10 of the computation node 1-2 completes the partial arithmetic operation (step S204). The OAM processing section 12 of the computation node 1-2 may record completion of the partial arithmetic operation for the own node by setting a flag in the received OAM packet. The OAM processing section 122 of the computation node 1-2 detects, from states in the OAM packet, that all of the partial arithmetic operations involved with the collective communication are completed, that is, synchronization is completed. Thereafter, the network processing unit 12 of the computation node 1-2 transmits an instruction to start the collective communication to the computation node 1-3 (step S205).

For example, the computation node 1-2 transmits a partial arithmetic operation result for the own node to the computation node 1-3, and the addition section 121 provided in the network processing unit 12 of the computation node 1-3 performs the entire arithmetic operation that obtains a sum of the partial arithmetic operation results obtained by the computation nodes 1-2, 1-3. Thereafter, an entire arithmetic operation result is distributed to the computation nodes 1-1 to 1-3.

As described above, according to the second embodiment, the division information (specification information) that specifies, among the plurality of computation nodes 1-1 to 1-3, computation nodes 1 that are to calculate partial arithmetic operations involved with collective communication is notified from a computation node 1 that is the master node to the other computation nodes 1. At the computation nodes 1 that have received the division information, OAM packet processing including issuance of an OAM packet and setting of a flag is performed between the computation nodes 1 indicated by the division information.

Accordingly, the computation nodes 1 receive the OAM packet that indicates completion of the partial arithmetic operations involved with the collective communication to be performed by the own node, start the collective communication on an occasion when synchronization is completed, and terminate the processing when the collective communication is completed. Accordingly, collective communication can be started more efficiently, and even if the number of computation nodes connected to the communication network increases, the cooperative processing among the computation nodes can be performed at higher speed.

### Third Embodiment

Next, a third embodiment of the present invention will be described. In a description below, the same components as in the first and second embodiments are denoted by the same reference signs, and a description thereof is omitted.

The third embodiment is different from the first and second embodiments in a point that a plurality of computation nodes 1-1 to 1-3 are included in a network in a tree topology. Moreover, another difference from the first and second embodiments is that a distributed deep learning system according to the third embodiment includes a collection node 2 that performs an entire arithmetic operation.

### Configuration of the Distributed Deep Learning System

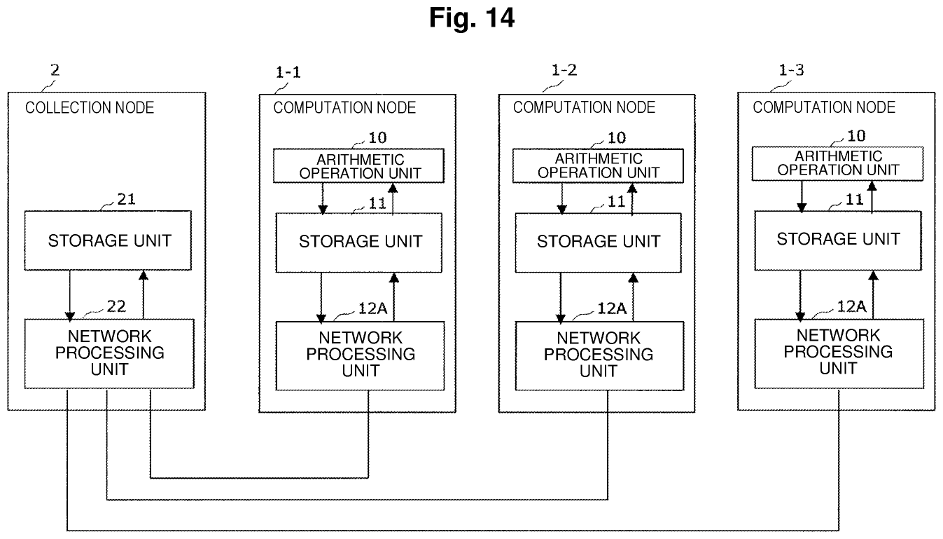

FIG. 14 is a block diagram showing an example of a configuration of the distributed deep learning system according to the present embodiment. In the distributed deep learning system, for example, three computation nodes 1-1 to 1-3 are connected via one collection node 2, in a tree network topology. In the present embodiment, computation for matrix multiplication in a neural network is performed by the plurality of computation nodes 1-1 to 1-3 and the collection node 2.

A configuration of each of the computation nodes 1-1 to 1-3 according to the present embodiment is different from the configuration in the first and second embodiments described with FIG. 6 in a point that a network processing unit (first network processing device) 12A does not include the addition section 121 that performs an entire arithmetic operation. Accordingly, each of the computation nodes 1-1 to 1-3 according to the present embodiment performs only a partial arithmetic operation that is part of the matrix multiplication, and transmits a partial arithmetic operation result to the collection node 2. An entire arithmetic operation that obtains a sum of the partial arithmetic operation results is performed by the collection node 2.

### Functional Block of the Collection Node

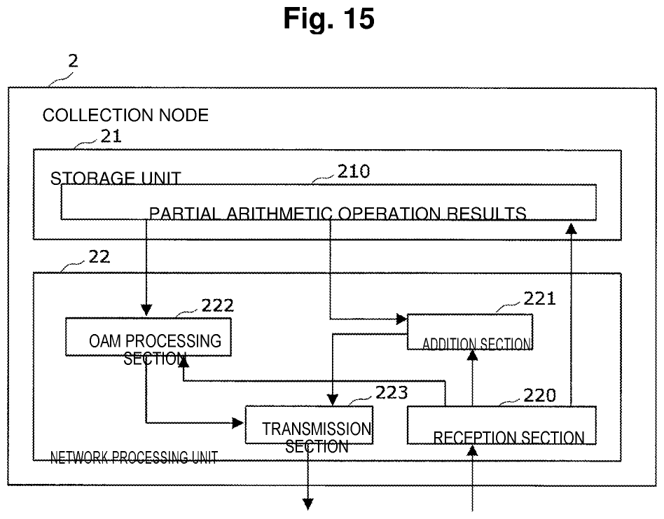

As shown in FIGS. 14 and 15, the collection node 2 includes a storage unit (second storage device) 21 and a network processing unit (second network processing device) 22. The collection node 2 generates an OAM packet and transmits the OAM packet to computation nodes 1 to be involved with collective communication. Moreover, on an occasion when the partial arithmetic operations are completed at all of the computation nodes 1 to be involved with the collective communication, the collection node 2 instructs the computation nodes 1 to start collection, and partial arithmetic operation results are collected at the collection node 2.

The collection node 2 collects the partial arithmetic operation results computed by the plurality of computation nodes 1-1 to 1-3, performs the entire arithmetic operation including addition processing, and distributes an obtained entire arithmetic operation result to the plurality of computation nodes 1-1 to 1-3.

As shown in FIG. 15, the storage unit 21 stores the partial arithmetic operation results 210 obtained by the computation nodes 1-1 to 1-3, respectively.

The network processing unit 22 includes a reception section (third reception circuit, fourth reception circuit) 220, an addition section (addition circuit) 221, an OAM processing section (second OAM processing circuit) 222, and a transmission section (third transmission circuit, fourth transmission circuit) 223.

The reception section 220 receives OAM packets in which a record is made by the respective OAM processing sections 122 of the plurality of computation nodes 1-1 to 1-3, from the plurality of computation nodes 1-1 to 1-3. The reception section 220 receives the partial arithmetic operation result from each of the plurality of computation nodes 1-1 to 1-3. The received partial arithmetic operation results are stored in the storage unit 21.

The addition section 221 calculates the entire arithmetic operation result that is a sum of the partial arithmetic operation results from the plurality of computation nodes 1-1 to 1-3, received by the reception section 220. The addition section 221 can be configured by using, for example, an addition circuit using a logic circuit.

For example, when the specific example described with FIGS. 2 to 5 is used, the outputs of the hidden layer h₂ can be obtained by adding up the partial arithmetic operation results obtained by the computation nodes 1-1, 1-2. The addition section 221 adds up the partial arithmetic operation results obtained by the computation nodes 1-1 and 1-2, respectively, and thus obtains the entire arithmetic operation result that is the outputs of the hidden layer h₂.

The OAM processing section 222 generates OAM packets in which the plurality of computation nodes 1-1 to 1-3 are to record, respectively, whether or not the respective partial arithmetic operation for the computation node 1 is completed. Moreover, based on states in the OAM packets received by the reception section 220, the OAM processing section 222 generates collection start instructions to be transmitted to a plurality of computation nodes 1 to be involved with collective communication. The OAM processing section 222 issues the collection start instructions on an occasion when the partial arithmetic operations are completed by all of the computation nodes 1 to be involved with the collective communication, that is, when synchronization is completed.

For example, when an example in FIGS. 2 to 5 is used, the OAM processing section 222 generates OAM packets to be transmitted to the computation nodes 1-1, 1-2. Moreover, based on flag values in the OAM packets, the OAM processing section 222 detects that the partial arithmetic operations are completed by the computation nodes 1-1, 1-2, and generates collection start instructions.

The transmission section 223 transmits the OAM packets generated by the OAM processing section 222 to the computation nodes 1-1 to 1-3. The transmission section 223 transmits collection start instructions generated by the OAM processing section 222 to the involved computation nodes 1. The transmission section 223 distributes an entire arithmetic operation result obtained by the addition section 221 to the plurality of computation nodes 1-1 to 1-3.

### Hardware Configuration of the Collection Node

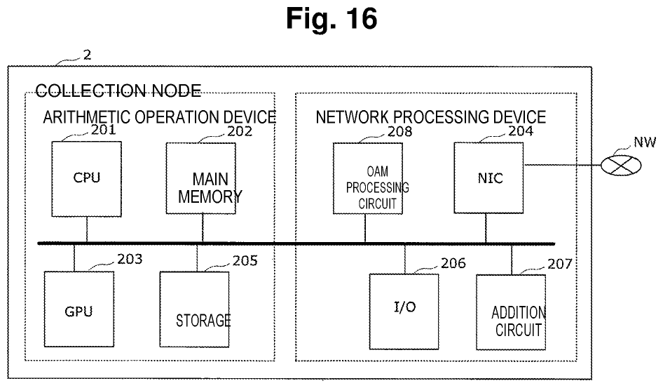

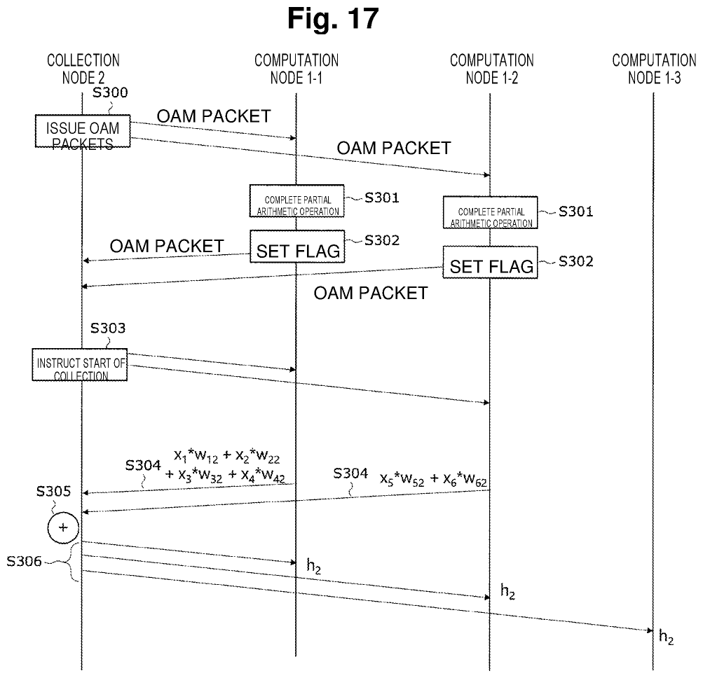

Next, an example of a hardware configuration implementing the collection node 2 including the above-described functions will be described with reference to a block diagram in FIG. 16.

As shown in FIG. 13, the collection node 2 can be implemented, for example, by a computer including a CPU 201, a main memory 202, a GPU 203, an NIC 204, a storage 205, and an I/O 206, and a program that controls such hardware resources.

The main memory 202 stores beforehand a program for causing the CPU 201 and the GPU 203 to perform various control and arithmetic operations. The various functions of the collection node 2, such as the addition section 221 and the OAM processing section 222 shown in FIG. 15, are implemented by the CPU 201, the GPU 203, and the main memory 202.

The NIC 204 is an interface circuit for providing network connection with the computation nodes 1-1 to 1-3 and various external electronic devices. The NIC 204 implements the reception section 220 and the transmission section 223 in FIG. 15.

The storage 205 includes a readable-writable recording medium and a drive device for reading from and writing into the recording medium various information such as a program and data. For the storage 205, a hard disk as a recording medium or a semiconductor memory such as a flash memory can be used. The storage 205 implements the storage unit 21 described with FIG. 15.

The storage 205 includes a program storage area in which programs for causing the collection node 2 to perform OAM packet processing, processing of collecting partial arithmetic operation results, entire arithmetic operation processing, and distribution processing, are stored. The storage 205 may include a backup area for backing up, for example, the above-mentioned data and programs.

The I/O 206 includes a network port that receives a signal from an external device as input and outputs a signal to an external device. For the network port, for example, as many network ports as the number of computation nodes 1-1 to 1-3 can be provided. Alternatively, a single network port can be provided by connecting the collection node 2 to the computation nodes 1-1 to 1-3 via a network switch.

For an addition circuit 207, for example, an addition circuit including a basic logic gate, or the like can be used. The addition circuit 207 implements the addition section 221 described with FIG. 15. In the present embodiment, the addition circuit 207 is provided to the network processing device including the NIC 204 and the I/O 206. The arithmetic operation device includes the CPU 201, the main memory 202, the GPU 203, and the storage 205.

An OAM processing circuit 208 is implemented by, for example, a complex logic gate built by combining basic logic gates, or the like. Alternatively, the OAM processing circuit 208 can be implemented as a dedicated circuit such as an ASIC, or as a combination of an electric circuit and a program. In the present embodiment, similarly to the addition circuit 207, the OAM processing circuit 208 is provided to the transmission path-side network processing device including the NIC 204 and the I/O 206.

### Sequence of Operation in the Distributed Deep Learning System

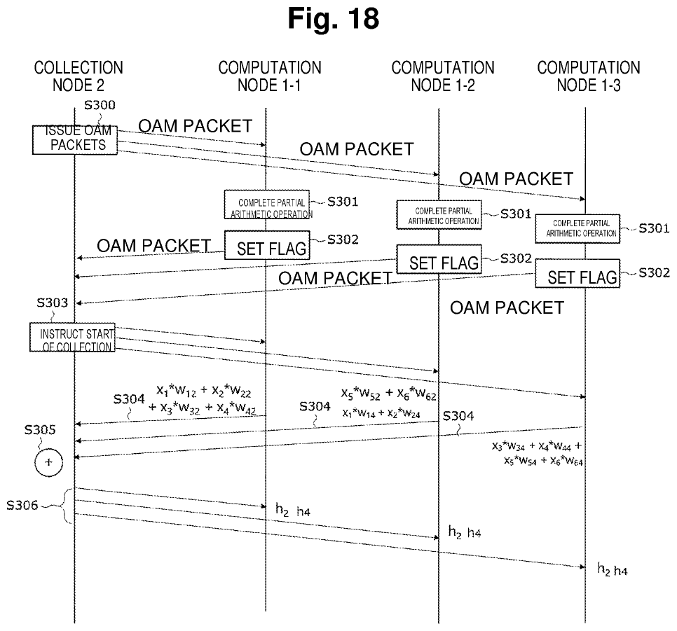

Next, operation in the distributed deep learning system including the collection node 2 with the above-described components and the computation nodes 1-1 to 1-3 will be described with reference to sequence charts in FIGS. 17 and 18. In the following, a description will be given of a case of obtaining the outputs of the hidden layers h₂, h₄ described with FIGS. 2 to 5, in the distributed deep learning system.

As shown in FIG. 17, the OAM processing section 222 of the collection node 2 generates OAM packets, and the transmission section 223 transmits the OAM packets to computation nodes 1 to be involved with collective communication (step S300). For example, the collection node 2 transmits the OAM packets to the computation nodes 1-1, 1-2 which are involved with collective communication that is related to the outputs of the hidden layer h₂ and is preset in the OAM processing section 222.

Thereafter, at each of the computation nodes 1-1, 1-2, a partial arithmetic operation is completed (step S301). A partial arithmetic operation result obtained by each of the computation nodes 1-1, 1-2 is stored in the respective storage unit 11. Next, at each of the computation nodes 1-1, 1-2, when the OAM packet is received from the collection node 2, the OAM processing section (first OAM processing circuit) 122 sets a flag value of “1” that indicates completion of the partial arithmetic operation for the own node (step S302). Each of the computation nodes 1-1, 1-2 transmits the flagged OAM packet to the collection node 2.

Next, the collection node 2 receives the OAM packets from the computation nodes 1-1, 1-2. The OAM processing section 222 of the collection node 2 detects, from the flag values in the OAM packets received from the computation nodes 1-1, 1-2, that the partial arithmetic operations required to perform an entire arithmetic operation are completed. The OAM processing section 222 generates a collection start instruction to collect the partial arithmetic operation result from each of the computation nodes 1-1, 1-2 (step S303). The generated collection start instructions are transmitted to the computation nodes 1-1, 1-2.

Next, when the collection start instruction from the collection node 2 is received, each of the computation nodes 1-1, 1-2 transmits the partial arithmetic operation result obtained by the own node to the collection node 2 (step S304). Thereafter, the addition section 221 of the collection node 2 performs the entire arithmetic operation that obtains a sum of the partial arithmetic operation results collected from the computation nodes 1-1, 1-2 (step S305). Thereafter, at the collection node 2, the transmission section 223 distributes an obtained entire arithmetic operation result to the computation nodes 1-1 to 1-3.

Note that in FIG. 17, a description is given of a case in which the collection node 2 transmits the OAM packets only to the computation nodes 1-1, 1-2 that compute the partial arithmetic operations required to start the entire arithmetic operation related to the outputs of the hidden layer h₂. However, as shown in FIG. 18, the collection node 2 can transmit OAM packets to all of the computation nodes 1-1 to 1-3 in step S300, and on an occasion when partial arithmetic operations required to start entire arithmetic operations related to outputs of a plurality of hidden layers, for example, the hidden layers h₂, h₄, are completed by all of the computation nodes 1-1 to 1-3 (steps S301, 302), the collection node 2 can transmit collection start instructions to the computation nodes 1-1 to 1-3 (step S303).

As described above, according to the third embodiment, the collection node 2 transmits OAM packets to a plurality of computation nodes 1 to be involved with collective communication. When the collection node 2 detects, from a state in the OAM packet recorded and returned by each computation node 1, that the partial arithmetic operation required to perform the entire arithmetic operation is completed at each computation node 1, the collection node 2 determines completion of synchronization and transmits collection start instructions to the computation nodes 1 in order to collect partial arithmetic operation results.

As described above, since collection instructions are issued to the computation nodes 1-1 to 1-3 on an occasion when the partial arithmetic operations are completed by the plurality of computation nodes 1-1 to 1-3, the collection node 2 can more efficiently collect the partial arithmetic operation results from the computation nodes 1-1 to 1-3, and can obtain the entire arithmetic operation result.

Moreover, since the collection node 2 according to the present embodiment includes, in the network processing unit 22, the addition section 221 that performs the entire arithmetic operation and the OAM processing section 222 that performs OAM packet issuance and processing, the arithmetic operation unit 10 is not needed in the collection node 2. Accordingly, in comparison with a conventional example in which addition processing and OAM processing are performed by the arithmetic operation unit 10 with software, even if the number of computation nodes connected to the communication network increases, the cooperative processing among the computation nodes can be performed at higher speed.

Moreover, according to the third embodiment, an OAM packet can be transmitted to a specified computation node 1, and the number of OAM frames can be reduced. Accordingly, higher-speed distributed deep learning processing can be achieved.

Note that the described embodiments illustrate cases in which entire training of a neural network is performed in such a manner that a neural network model is divided and the plurality of computation nodes 1-1 to 1-3 perform distributed learning, whereby collective communication is sped up. However, processing can be sped up by applying any of the distributed deep learning systems according to the embodiments not only to learning processing, but also to large-scale matrix computation including matrix product-sum operations, such as inference processing.

Hereinabove, some embodiments of the distributed deep learning system and the distributed deep learning method of the present invention have been described. However, the present invention is not limited to the described embodiments, and it is possible to make various modifications that can be conceived by persons ordinarily skilled in the art within the scope of the invention as described in claims.

### REFERENCE SIGNS LIST

1, 1-1, 1-2, 1-3 Computation node
10 Arithmetic operation unit
11 Storage unit
12 Network processing unit
110 Partial arithmetic operation results
111 Entire arithmetic operation results
120 Reception section
121 Addition section
122 OAM processing section
123 Transmission section
101 CPU
102 Main memory
103 GPU
104 NIC
105 Storage
106 I/O
107 Addition circuit
108 OAM processing circuit

1-8. (canceled)

9. A distributed deep learning system comprising a plurality of computation nodes mutually connected through a communication network, wherein each of the plurality of computation nodes includes:
an arithmetic operation device configured to perform computation for matrix multiplication included in arithmetic operation processing in a neural network, and output a first arithmetic operation result;
a first storage device configured to store the first arithmetic operation result outputted from the arithmetic operation device; and
a network processing device including:
a first transmission circuit configured to transmit the first arithmetic operation result stored in the first storage device to another computation node,
a first reception circuit configured to receive the first arithmetic operation result from the other computation node,
an addition circuit configured to calculate a second arithmetic operation result that is a sum of the first arithmetic operation result stored in the first storage device and the first arithmetic operation result from the other computation node received by the first reception circuit,
a second transmission circuit configured to transmit the second arithmetic operation result to the other computation node,
a second reception circuit configured to receive the second arithmetic operation result from each of the other computation node,
a third reception circuit configured to receive a notification packet indicating states of the plurality of computation nodes,
an operation administration maintenance (OAM) processing circuit configured to make a record, in the notification packet received by the third reception circuit, of whether or not the first arithmetic operation result is outputted from the arithmetic operation device of the own node, and
a third transmission circuit configured to transmit the notification packet including the record made by the OAM processing circuit to the other computation node,
wherein the OAM processing circuit, depending on the state of the other computation node indicated by the notification packet, causes the first transmission circuit to transmit the first arithmetic operation result stored in the first storage device to the other computation node.

10. The distributed deep learning system according to claim 9, wherein
each of the plurality of computation nodes further includes a second storage device configured to store the second arithmetic operation result.

11. The distributed deep learning system according to claim 9, wherein
any one computation node of the plurality of computation nodes is designated as a master node, and a plurality of the other computation nodes are designated as slave nodes that are controlled by the master node.

12. The distributed deep learning system according to claim 11, wherein in the network processing device included in the one computation node,
the OAM processing circuit generates the notification packet,
the third transmission circuit transmits the generated notification packet to the plurality of the other computation nodes, and
when the notification packet including records made by the plurality of the other computation nodes indicates that the first arithmetic operation result is already outputted at each of the plurality of the other computation nodes, the OAM processing circuit causes the addition circuit to compute the second arithmetic operation result that is a sum of the first arithmetic operation results outputted from the respective arithmetic operation devices included in the plurality of the other computation nodes.

13. The distributed deep learning system according to claim 11, wherein in the network processing device included in the one computation node, the OAM processing circuit generates specification information that specifies, among the plurality of the other computation nodes, a plurality of specified computation nodes that output a plurality of the first arithmetic operation results required for the addition circuit to calculate the second arithmetic operation result,
the network processing device included in the one computation node further includes a fourth transmission circuit configured to transmit the specification information to the plurality of the other computation nodes,
the network processing device included in each of the plurality of the other computation nodes further includes a fifth reception circuit configured to receive the specification information, and
in the network processing device included in each of the plurality of the other computation nodes, when the own node is included in the plurality of specified computation nodes specified by the specification information, the OAM processing circuit, depending on the states of the plurality of specified computation nodes indicated by the notification packet, causes the first transmission circuit to transmit the first arithmetic operation result stored in the first storage device to another computation node specified by the specification information.

14. A distributed deep learning system comprising a plurality of computation nodes and a collection node mutually connected through a communication network, wherein each of the plurality of computation nodes includes:
an arithmetic operation device configured to perform computation for matrix multiplication included in arithmetic operation processing in a neural network, and output a first arithmetic operation result;
a first network processing device including:
a first transmission circuit configured to transmit the first arithmetic operation result outputted from the arithmetic operation device to the collection node,
a first reception circuit configured to receive, from the collection node, a second arithmetic operation result that is a sum of the first arithmetic operation results computed at the plurality of computation nodes,
a second reception circuit configured to receive a notification packet indicating states of the plurality of computation nodes,
a first operation administration maintenance (OAM) processing circuit configured to make a record, in the notification packet received by the second reception circuit, of whether or not the first arithmetic operation result is outputted from the arithmetic operation device of the own node, and
a second transmission circuit configured to transmit the notification packet including the record made by the first OAM processing circuit to the collection node; and
a first storage device configured to store the second arithmetic operation result received by the first reception circuit,
wherein the first OAM processing circuit, based on an instruction from the collection node, is configured to cause the first transmission circuit to transmit the first arithmetic operation result stored in the first storage device to the collection node, and
wherein the collection node includes a second network processing device including
a second OAM processing circuit configured to generate the notification packet,
a third transmission circuit configured to transmit the generated notification packet to each of the plurality of computation nodes,
a third reception circuit configured to receive, from each of the plurality of computation nodes, the notification packet including the record made by the first OAM processing circuit of each of the plurality of computation nodes,
a fourth reception circuit configured to receive the first arithmetic operation results from the plurality of computation nodes,
an addition circuit configured to calculate the second arithmetic operation result that is a sum of the first arithmetic operation results received by the fourth reception circuit, and
a fourth transmission circuit configured to transmit the second arithmetic operation result obtained by the addition circuit to the plurality of computation nodes,
wherein the second OAM processing circuit, depending on the states of the plurality of computation nodes indicated by the respective notification packets, is configured to instruct the plurality of computation nodes to transmit the first arithmetic operation result to the collection node, in order to collect the first arithmetic operation results obtained at the plurality of computation nodes.

15. The distributed deep learning system according to claim 14, wherein the plurality of computation nodes and the collection node are included in a star communication network in which each of the plurality of computation nodes and the collection node are mutually connected.

16. A distributed deep learning method, the method performed by a plurality of computation nodes mutually connected through a communication network, the method comprising:
performing computation for matrix multiplication included in arithmetic operation processing in a neural network, and outputting a first arithmetic operation result;
storing, in a first storage device, the first arithmetic operation result;
transmitting the first arithmetic operation result stored in the first storage device to another computation node,
receiving the first arithmetic operation result from the other computation node,
calculating a second arithmetic operation result that is a sum of the first arithmetic operation result stored in the first storage device and the first arithmetic operation result received from the other computation node,
transmitting the second arithmetic operation result to the other computation node,
receiving the second arithmetic operation result from the other computation node,
receiving a notification packet indicating states of the plurality of computation nodes,
making a record, in the notification packet received, of whether or not the first arithmetic operation result is outputted at the own node, and
transmitting the notification packet including the record made to the other computation node,
wherein depending on the state of the other computation node indicated by the notification packet, causing the first arithmetic operation result stored in the first storage device to be transmitted to the other computation node.

17. The distributed deep learning method according to claim 16, wherein
storing, in a second storage device, the second arithmetic operation result.

18. The distributed deep learning method according to claim 16, wherein
any one computation node of the plurality of computation nodes is designated as a master node, and a plurality of the other computation nodes are designated as slave nodes that are controlled by the master node.

19. The distributed deep learning method according to claim 18 further comprising:
generating the notification packet by the one computation node;
transmitting the generated notification packet to the plurality of the other computation nodes, and
when the notification packet including records made by the plurality of the other computation nodes indicates that the first arithmetic operation result is already outputted at each of the plurality of the other computation nodes, computing the second arithmetic operation result that is a sum of the first arithmetic operation results outputted from the respective arithmetic operation devices included in the plurality of the other computation nodes.

20. The distributed deep learning method according to claim 18 further comprising:
generating, by the one computation node, specification information that specifies, among the plurality of the other computation nodes, a plurality of specified computation nodes that output a plurality of the first arithmetic operation results required for the second arithmetic operation result,
transmitting, by the one computation node, the specification information to the plurality of the other computation nodes,
receiving, by the other computation nodes, the specification information, and
when the own node is included in the plurality of specified computation nodes specified by the specification information and depending on the states of the plurality of specified computation nodes indicated by the notification packet, transmitting the first arithmetic operation result stored in the first storage device to another computation node specified by the specification information.
